(19) United States
(12) Patent Application Publication
(10) Pub. No.: US 2010/0331059 A1
(43) Pub. Date: Dec. 30, 2010

(54) Apparatus with swivel hinge and associated method

(76) Inventors: Jeffrey Apgar, Escondido, CA (US); Edward Liljegren, San Diego, CA (US)

Correspondence Address: HARRINGTON & SMITH, 4 RESEARCH DRIVE, Suite 202, SHELTON, CT, 06484-6212, US

(21) Appl. No.: 12/459,381

(22) Filed: Jun. 30, 2009

(51) Int. Cl. H04M 1/00; E05D 9/00

(52) U.S. Cl. 455/575.1; 16/385

(57) ABSTRACT

Disclosed herein is an apparatus. The apparatus includes a first housing member, a second housing member, and a rotatable hinge. The first housing member includes a first magnet. The second housing member includes a second magnet. The second magnet is opposite the first magnet. The rotatable hinge is between the first housing member and the second housing member. The rotatable hinge includes an aperture and a central axis. The aperture is adapted to be accessible from an exterior portion of the apparatus. The first housing member and the second housing member are rotatable about the central axis. The aperture extends through the first housing member and the second housing member.

### TECHNICAL FIELD

The application relates generally to an apparatus with a swivel hinge and an associated method.

### BACKGROUND

Swivel type (or swivel style) form factors for mobile devices are known. The swivel type form factor offers interesting design possibilities, and makes it possible to achieve a compact size in a closed position of the device, while offering ample space for many features and functionalities in an open position.

When designing swivel-type devices, one consideration may be to provide the swiveling mechanism with a locking means that secures the mechanism firmly to an open or a closed position. In conventional solutions this may be done by building the locking mechanism inside the (swivel) hinge itself.

Additionally, magnetic locking mechanisms in mobile devices are also known, such as in NOKIA® Model No. 6600 fold, for example.

As consumers demand increased functionality from electronic devices, there is a need to provide improved devices having increased capabilities while maintaining robust and reliable product configurations.

### SUMMARY

The foregoing and other problems are overcome, and other advantages are realized, by the use of the exemplary embodiments of this invention. Various aspects of examples of the invention are set out in the claims.

According to a first aspect of the present invention, an apparatus is disclosed. The apparatus includes a first housing member, a second housing member, and a rotatable hinge. The first housing member includes a first magnet. The second housing member includes a second magnet. The second magnet is opposite the first magnet. The rotatable hinge is between the first housing member and the second housing member. The rotatable hinge includes an aperture and a central axis. The aperture is adapted to be accessible from an exterior portion of the apparatus. The first housing member and the second housing member are rotatable about the central axis. The aperture extends through the first housing member and the second housing member.

According to a second aspect of the present invention, an apparatus is disclosed. The apparatus includes a first housing member, a second housing member, and a hinge. The first housing member includes a first opening and a first magnet. At least a portion of the first housing member forms a front face of the apparatus. The second housing member includes a second opening and a second magnet. At least a portion of the second housing member forms a rear face of the apparatus. The hinge is between the first opening and the second opening. The first housing member is adapted to be pivotable about the hinge. The first magnet and the second magnet are opposite each other and spaced from the hinge. The first opening and the second opening form a hole extending from the front face to the rear face of the apparatus.

According to a third aspect of the present invention, a method is disclosed. A first housing member comprising a first opening and a first magnet is provided. A second housing member comprising a second opening and a second magnet is provided. The first opening is aligned with the second opening. The second magnet is opposite the first magnet. A rotatable hinge is connected between the first opening and the second opening. The rotatable hinge includes an aperture having a central axis. The first housing member and the second housing member are rotatable about the central axis. The aperture extends from an exterior side face of the first housing member to an exterior side face of the second housing member.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a front view of the electronic device shown in FIG. 1 in an open position;

FIG. 3 is a side view of the electronic device shown in FIG. 1 in a closed position;

FIG. 4 a side view of the electronic device shown in FIG. 1 in an open position;

FIG. 5 is a cross section view of the device shown in FIG. 2 taken along the lines 5-5;

FIG. 6 is a partial section view of the device shown in FIG. 1;

FIG. 7 is an enlarged view of a portion of the cross section view shown in FIG. 5;

FIG. 8 is front view of another electronic device incorporating features of the invention;

FIG. 9 is a front view of another electronic device incorporating features of the invention; and

FIG. 10 is a block diagram of an exemplary method of the device shown in FIG. 1.

### DETAILED DESCRIPTION OF THE DRAWINGS

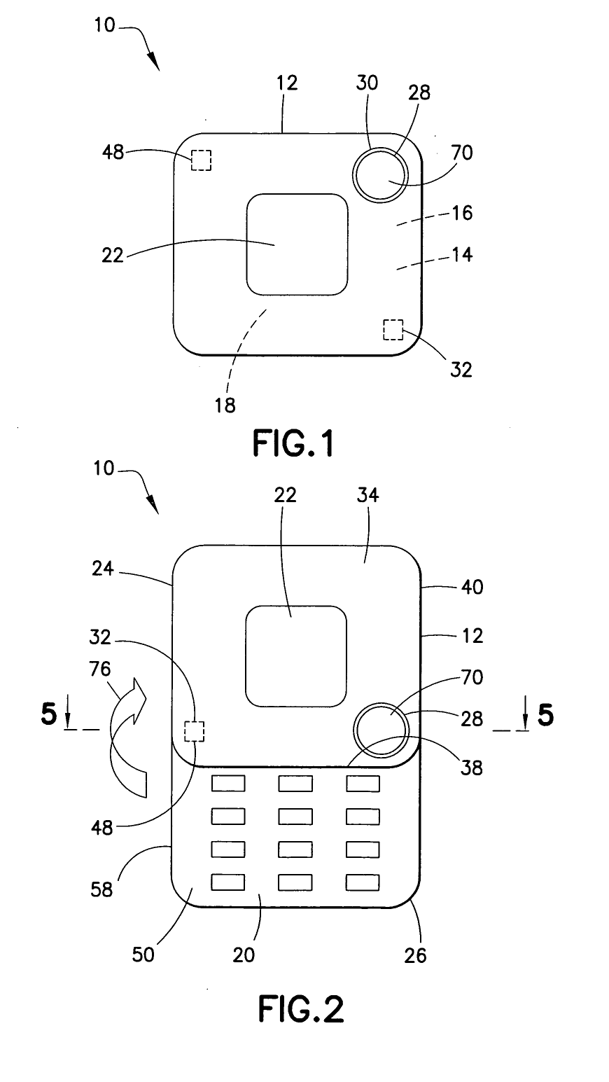

An example embodiment of the present invention and its potential advantages are understood by referring to FIGS. 1-9 of the drawings.

Referring to FIGS. 1 and 2, there are shown front views of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention shown in FIGS. 1 and 2, the device 10 is a multi-function portable electronic device. However, in alternate embodiments, features of the various embodiments of the invention could be used in any suitable type of portable electronic device such as a mobile phone, a gaming device, a music player, a notebook computer, or a PDA, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. The housing 12 includes a first housing member 24 and a second housing member 26. The housing members 24, 26 are movably connected to each other by a swivel type (or rotary) hinge 28, and are adapted to provide a closed position (as shown in FIG. 1) and an open position (as shown in FIG. 2) of the device 10. It should be noted that in alternate embodiments, more than two housing members could be provided. It should also be noted that in alternate embodiments, the device 10 can have any suitable type of features as known in the art.

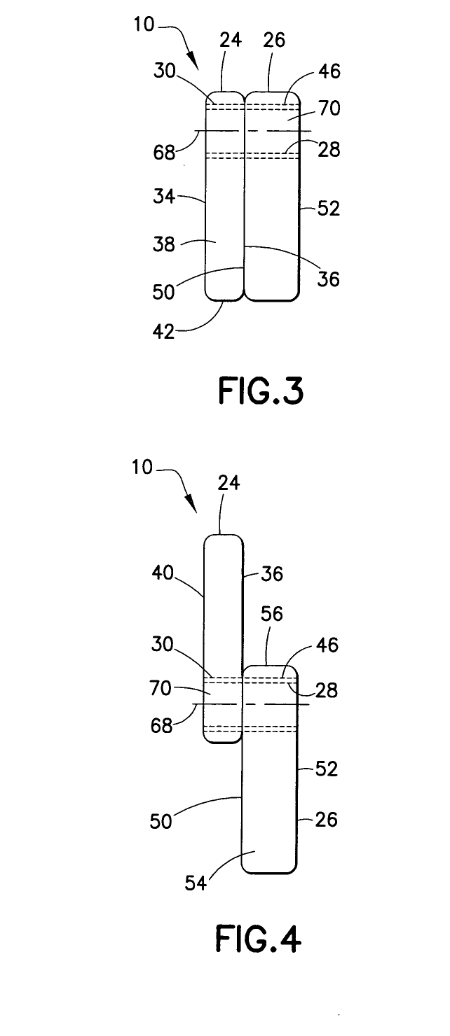

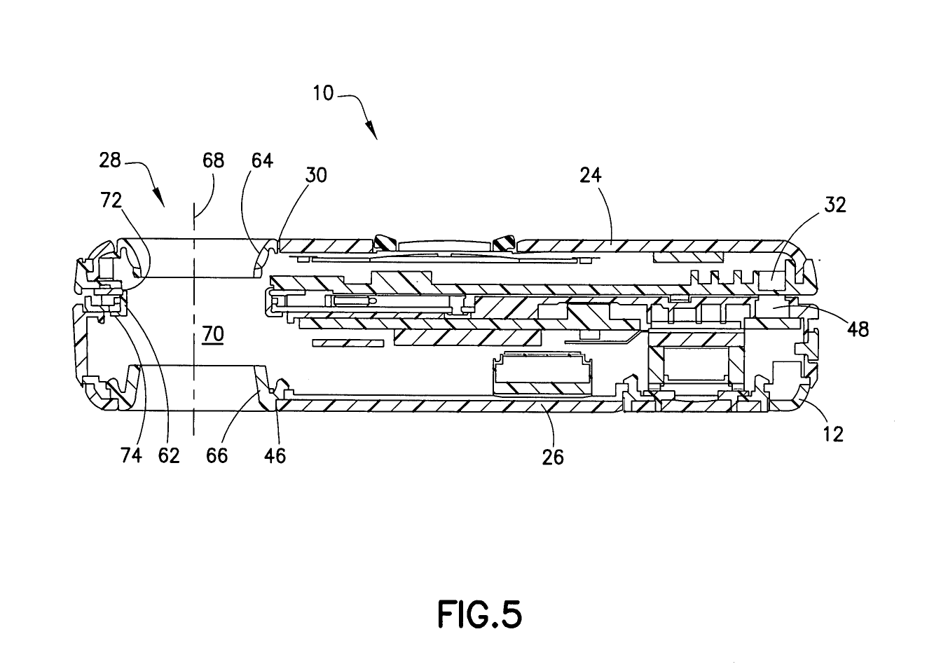

Referring now also to FIGS. 3-6, the first housing member 24 comprises an opening 30 and a magnet 32. The opening 30 extends from an exterior front side face 34 of the first housing member 24 to an exterior rear side face 36 of the first housing member 24, and thus extends through an entire thickness of the first housing member 24. When the device 10 is in a closed position (see FIGS. 1, 3), the front side face 34 forms substantially an entire front face of the device 10. In this closed position, the rear side face 36 faces and is adjacent the second housing member 26. When the device 10 is in an open position (see FIGS. 2, 4), the front side face 34 forms a portion (or upper portion) of the front face of the device 10. In this open position, the rear side face 36 forms a portion (or upper portion) of the rear face of the device 10.

The opening 30 may be suitably located proximate side edges of the housing member 24. For example, in this embodiment, the opening 30 is proximate a corner of the housing member 24 between exterior lateral side faces 38, 40. However, the opening 30 may be provided at any suitable location.

The magnet 32 may be suitably located proximate side edges of the housing member 24 and spaced at a distance from the opening 30. For example, in this embodiment, the magnet 32 is proximate another corner of the housing member 24 between exterior lateral side faces 38, 42. However, the magnet 32 may be provided at any suitable location. The magnet 32 may also be attached to an interior portion of the housing member 24 proximate the exterior rear side face 36 (best shown in FIGS. 5-7). According to various embodiments of the invention, the first housing member may comprise a barrier portion 44 between the exterior rear side face 36 and the magnet.

It should be noted that although the figures illustrate the first housing member 24 as comprising a single display, any suitable device configuration may be provided. According to one example of the invention, the first housing member may comprise two or more displays. According to another example of the invention, the first housing member may comprise a user input region. According to yet another example of the invention, the first housing member may not comprise any displays or input regions. However, it should be understood that these are merely non-limiting examples and any suitable housing member configuration may be provided.

The second housing member 26 comprises an opening 46 and a magnet 48. The opening 46 extends from an exterior front side face 50 of the second housing member 26 to an exterior rear side face 52 of the second housing member 26, and thus extends through an entire thickness of the second housing member 26. When the device 10 is in the closed position (see FIGS. 1, 3), the front side face 50 faces and is adjacent the first housing member 24. In this closed position, the rear side face 52 forms substantially an entire rear face of the device 10. When the device 10 is in an open position (see FIGS. 2, 4), the front side face 50 forms a portion (or lower portion) of the front face of the device 10. In this open position, the rear side face 52 forms a portion (or lower portion) of the rear face of the device 10.

The opening 46 may be suitably located proximate side edges of the housing member 26. For example, in this embodiment, the opening 46 is proximate a corner of the housing member 26 between exterior lateral side faces 54, 56. However, the opening 46 may be provided at any suitable location.

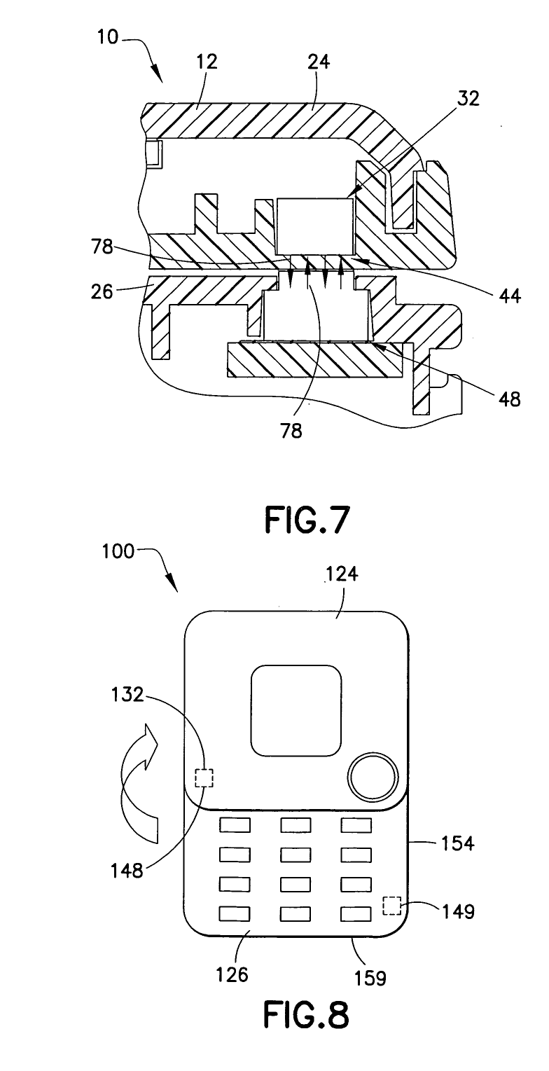

The magnet 48 may be suitably located proximate side edges of the housing member 26 and spaced at a distance from the opening 46. For example, in this embodiment, the magnet 48 is proximate another corner of the housing member 26 between exterior lateral side faces 56, 58. However, the magnet 48 may be provided at any suitable location. The magnet 48 may also be attached to an interior portion of the housing member 26 such that an end portion 60 of the magnet 48 is at the exterior front side face 50 (best shown in FIGS. 5-7). This configuration allows for the magnet 48 to be directly opposite the magnet 32 (when the device 10 is in the open position) with only the barrier portion 44 therebetween (best shown in FIG. 7). However, any suitable spacing between the magnets 32, 48 may be provided.

According to various embodiments of the invention, the magnets 32, 46 may be permanent magnets, however, in alternate embodiments, any suitable type of magnets or magnet members may be provided, such as electromagnets for example.

As shown in the figures, the openings 30, 46 are aligned with each other such that, together the openings 30, 46 form a hole extending through the device 10.

It should be noted that although the figures illustrate the second housing member 26 as comprising the user input region, any suitable device configuration may be provided. According to one example of the invention, the second housing member may only comprise a display. According to another example of the invention, the second housing member may comprise a display and a user input region. According to yet another example of the invention, the second housing member may not comprise any displays or input regions. However, it should be understood that these are merely non-limiting examples and any suitable housing member configuration may be provided.

It should further be understood that although the housing members are shown as having substantially square/rectangular shapes, any suitable shape configuration may be provided.

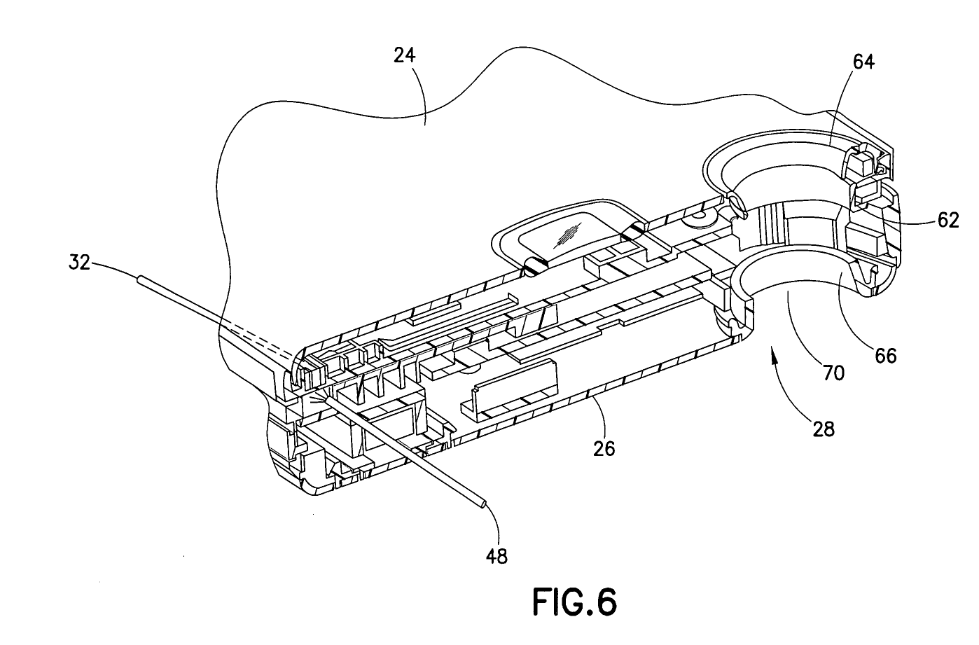

The hinge, or hinge assembly, 28 is connected between the first housing member 24 and the second housing member 26. The swivel (or rotary) type hinge assembly 28 may be any suitable type hinge configured to allow for a rotating or pivoting movement between the housing members 24, 26 when manipulated by a user of the device from the closed position to the open position, or from the open position to the closed position. According to one embodiment (best shown in FIGS. 5, 6), the hinge assembly 28 comprises a hinge member 62, a first hinge cover piece 64, and a second hinge cover piece 66. The hinge 28 is configured to swivel about a central axis 68 (see FIGS. 3-5). The hinge member 62, the first hinge cover piece 64, and the second hinge cover piece 66, each comprise a general annular shape aligned with the axis 68 such that the axis 68 forms a central axis of the openings in the annular member 62 and the annular pieces 64, 66. Together, the openings of the annular member 62 and the annular pieces 64, 66 form an aperture 70 extending through the hinge, or hinge assembly, 28.

The hinge member 62 comprises a first end 72 and a second end 74. The first end 72 extends into the opening 30 of the first housing member 24. The first end 72 may be connected to the opening 30 (proximate the rear face 36) in any suitable manner, such as by a press fit or a fastening operation for example. Similarly, the second end 74 extends into the opening 46 of the second housing member 26. The second end 74 may be connected to the opening 46 (proximate the front face 50) in any suitable manner, such as by a press fit or a fastening operation for example.

The first hinge cover piece 64 extends into the opening 30 of the first housing member 24 opposite the first end 72 of the hinge member 62. The first hinge cover piece 64 may be connected to the first housing member 24 (proximate the front face 34) in any suitable manner, such as by a press fit or a fastening operation for example. Similarly, the second hinge cover piece 66 extends into the opening 46 of the second housing member 26 opposite the second end 74 of the hinge member 62. The second hinge cover piece 66 may be connected to the second housing member 26 (proximate the rear face 52) in any suitable manner, such as by a press fit or a fastening operation for example.

The hinge 28 is adapted to allow for rotation (or pivoting) of the housing members 24, 26 about the central axis 68. In this example embodiment, a clockwise rotation (see arrow 76 in FIG. 2) of the first housing member 24 changes the configuration of the device from the closed position (FIGS. 1, 3) to the open position (FIGS. 2, 4). Similarly, a counter-clockwise rotation of the first housing member 24 changes the configuration of the device from the open position (FIGS. 2, 4) to the closed position (FIGS. 1, 3). However, it should be noted that the above mentioned rotation directions are merely provided as non-limiting examples and that according to some embodiments of the invention, the hinge and device may be configured to allow for any suitable rotation directions of the rotatably connected housing members.

The magnets 32, 48 provide a locking mechanism for at least one position about which the housing members rotate. As shown in FIG. 2, when the device is in the open position, the magnets 32, 48 may be opposite each other (and the barrier portion 44 prevents the magnets from actually touching). The manner of locking the phone 10 may be provided by the magnetic attraction (see arrows 76 in FIG. 7) between the magnets 32, 48 in the upper and lower halves 24, 26 of the phone 10. The attraction of the two magnets 32, 48 may assist the swivel hinge to “open” the phone 10 and maintain the relative static position of the two halves 24, 26 of the phone 10 in the “open” position.

The method of operation for the locking mechanism may be based upon, for example, principles of magnetic attraction of the two magnets with the opposite poles facing each other. For example, when two magnets with opposite polarities are facing each other, the magnetic fields will be attracted to each other (and provide a magnetic lock). This attraction may only be overcome with the application of a sufficient amount of mechanical force so that the magnetic fields can not sense the other opposite magnetic field.

The position of the two magnets 32, 48 may be located in any suitable portion of the upper and lower halves 24, 26 of the phone 10. However, according to some embodiments, the magnets may preferably be located in such a manner that when the phone 10 is in the “open” position, the magnetic fields of the two magnets will be attracted to each other. However, any suitable configuration may be provided.

Referring now also to FIG. 8, there is shown an electronic device 100 in accordance with another embodiment of the invention. Similar to the device 10, the device 100 comprises a first housing member 124 having a magnet (or first magnet) 132, a second housing member 126 having a magnet (or second magnet) 148, and a hinge assembly 128 rotatably connecting the housing members 124, 126 together. However, in this embodiment, the second housing member 126 comprises another magnet (or third magnet) 149.

The magnet 149 may be suitably located proximate side edges of the housing member 126 and spaced at a distance from the opening 146. For example, in this embodiment, the magnet 149 is proximate a corner of the housing member 126 between exterior lateral side faces 159, 154. However, the third magnet 149 may be provided at any suitable location.

The magnets 132, 148, 149 provide a locking mechanism for at least two positions about which the housing members rotate. As shown in FIG. 8, when the device is in the open position, the magnets 132, 148 may be opposite each other. The attraction of the two magnets 132, 148 may assist the swivel hinge to “open” the phone 100 and maintain the relative static position of the two halves 124, 126 of the phone 100 in the “open” position. When the device 100 is in the closed position (similar to as shown in FIG. 1), the magnets 132, 149 may be opposite each other. The attraction of the two magnets 132, 149 may assist the swivel hinge to “close” the phone 100 and maintain the relative static position of the two halves 124, 126 of the phone 100 in the “closed” position. The third magnet 149 may provide for an improved configuration when the device 100 is in the “closed” position, by controlling a gap tolerance between the two housing members 124, 126, of the device 100. The third magnet 149 may also help prevent the first housing member 124 from rotating past the second housing member 126 when moving the housing members of the device 100 from the “open” position to the “closed” position. Additionally, the third magnet 149 may also help prevent scratching from occurring on the exterior side faces of the housing members.

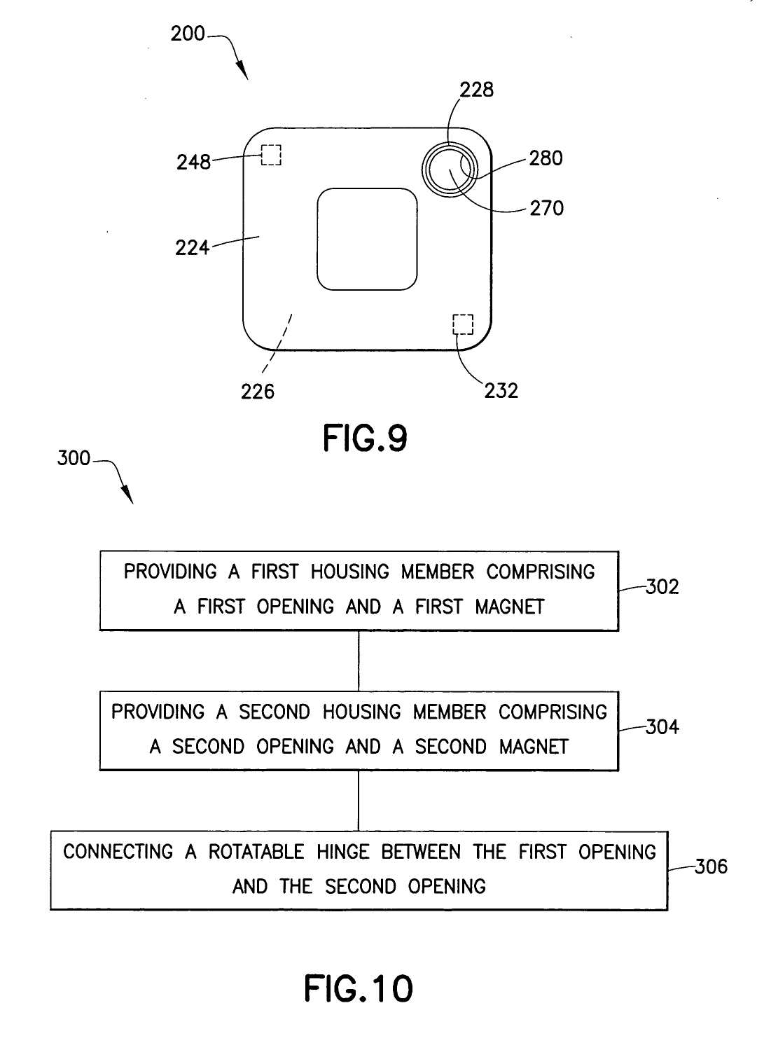

Referring now also to FIG. 9, there is shown an electronic device 200 in accordance with another embodiment of the invention. Similar to the device 10, 100 the device 200 comprises a first housing member 224 having a magnet (or first magnet) 232, a second housing member 226 having a magnet (or second magnet) 248, and a hinge assembly 228 rotatably connecting the housing members 224, 226 together. However, in this embodiment, the device further comprises a light ring 280. It should also be noted that the device 200 may also comprise another magnet (or third magnet) at the second housing member, similar to the device 100.

The light ring 280 may be suitably sized and shaped to be fitted proximate open ends of the hinge 228. The light ring 280 may further comprise an annular shape (as shown in FIG. 9) suitably sized to fit within the aperture 270. The annular shape of the light ring 280 may allow, for example, at least a portion of the aperture 270 to extend therethrough. The light ring 280 may be configured to emit light based upon a predetermined event. For example, the light ring 280 may illuminate a specified color when the device 200 receives a call. Additionally, the device may be configured such that specified colors may be set for different individual contacts in a contact list of the device 200, wherein when a call is received from one of the particular contacts, the specified color may be illuminated at the light ring 280. However, it should be noted that the light ring may be configured to emit light based on any other suitable predetermined event, such as an alarm or message notification function, for example.

FIG. 10 illustrates a method 300. The method 300 includes the following steps. Providing a first housing member comprising a first opening and a first magnet (step 302). Providing a second housing member comprising a second opening and a second magnet, wherein the first opening is aligned with the second opening, and wherein the second magnet is opposite the first magnet (step 304). Connecting a rotatable hinge between the first opening and the second opening, wherein the rotatable hinge comprises an aperture having a central axis, wherein the first housing member and the second housing member are rotatable about the central axis, and wherein the aperture extends from an exterior side face of the first housing member to an exterior side face of the second housing member (step 306). It should be noted that any of the above steps may be performed alone or in combination with one or more of the steps.

According to various exemplary embodiments of the invention, the device may be configured to activate features of the device in response to a change in position, such as from the “closed” position to the “open” position, for example. The change in position may be sensed in connection with the magnetic lock configuration. For example, if the first housing member is rotated to the locked “open” position, a software function or operating mode of the device may be launched or activated based on, at least partially, the orientation of the magnets. If the first housing member is rotated away from the locked “open” position, the software function or operating mode of the device may be minimized or de-activated based on, at least partially, the orientation of the magnets. However, these are merely listed as non-limiting examples, and any suitable configuration may be provided.

Without in any way limiting the scope, interpretation, or application of the claims appearing below, a technical effect of one or more of the example embodiments disclosed herein is a novel method of increasing the breakaway torque strength of a swivel or rotary type mobile phone. Another technical effect of one or more of the example embodiments disclosed herein is a novel type of hinge and lock mechanism for swivel-type mobile devices wherein a magnet assist feature increases a locking force of rotary actuator (or swivel hinge). Another technical effect of one or more of the example embodiments disclosed herein is providing increased holding torque for the hinge without contact locking of the device halves to each other, which thus minimizes or prevents scratching the device surfaces which are facing each other. Another technical effect of one or more of the example embodiments disclosed herein is providing the hinge of a swivel type device with a hole (or aperture) through it, which in addition to providing a distinct appearance for the device, could also be used for supporting the device. For example, when the device 10 is in the swivel closed position, a user may fit a pen or pencil (or any other suitably sized and shaped member) through the aperture 70, wherein the pen/pencil acts as a stand to hold up the device. This could be provided when the device is on a surface (such as a table or desk, for example) and one end of the pen/pencil extends through and contacts the aperture, and the opposite end of the pen/pencil also contacts the surface. Additionally, it should be noted that in other examples, the stand/support feature may be provided when the device is in the open position, or any other position, for example.

According to one example of the invention, an apparatus is disclosed. The apparatus includes a first housing member, a second housing member, and a rotatable hinge. The first housing member comprises a first magnet. The second housing member comprises a second magnet. The second magnet is opposite the first magnet. The rotatable hinge is between the first housing member and the second housing member. The rotatable hinge comprises an aperture and a central axis. The aperture is adapted to be accessible from an exterior portion of the apparatus. The first housing member and the second housing member are rotatable about the central axis. The aperture extends through the first housing member and the second housing member.

According to another example of the invention, an apparatus is disclosed. The apparatus includes a first housing member, a second housing member, and a hinge. The first housing member comprises a first opening and a first magnet. At least a portion of the first housing member forms a front face of the apparatus. The second housing member comprises a second opening and a second magnet. At least a portion of the second housing member forms a rear face of the apparatus. The hinge is between the first opening and the second opening. The first housing member is adapted to be pivotable about the hinge. The first magnet and the second magnet are opposite each other and spaced from the hinge. The first opening and the second opening form a hole extending from the front face to the rear face of the apparatus.

It should be understood that components of the invention can be operationally coupled or connected and that any number or combination of intervening elements can exist (including no intervening elements). The connections can be direct or indirect and additionally there can merely be a functional relationship between components.

Although various aspects of the invention are set out in the independent claims, other aspects of the invention comprise other combinations of features from the described embodiments and/or the dependent claims with the features of the independent claims, and not solely the combinations explicitly set out in the claims.

It should be understood that the foregoing description is only illustrative of the invention. Various alternatives and modifications can be devised by those skilled in the art without departing from the invention. It is also noted herein that while the above describes example embodiments of the invention, these descriptions should not be viewed in a limiting sense. Rather, there are several variations and modifications which may be made without departing from the scope of the present invention as defined in the appended claims.

1. An apparatus comprising:
a first housing member comprising a first magnet;
a second housing member comprising a second magnet, wherein the second magnet is opposite the first magnet; and
a rotatable hinge between the first housing member and the second housing member, wherein the rotatable hinge comprises an aperture and a central axis, wherein the aperture is adapted to be accessible from an exterior portion of the apparatus, wherein the first housing member and the second housing member are rotatable about the central axis, and wherein the aperture extends through the first housing member and the second housing member.

2. An apparatus as in claim 1 wherein the first housing member comprises a first opening, wherein the second housing member comprises a second opening, and wherein the rotatable hinge extends through the first opening and the second opening.

3. An apparatus as in claim 1 wherein the first magnet and the second magnet are spaced from the rotatable hinge.

4. An apparatus as in claim 1 wherein the first housing member comprises a barrier portion between the first magnet and the second magnet.

5. An apparatus as in claim 1 wherein the second magnet is opposite the first magnet when the apparatus is in an open position.

6. An apparatus as in claim 1 wherein the aperture is proximate a side edge of the apparatus.

7. An apparatus as in claim 1 wherein the apparatus is a mobile phone.

8. An apparatus comprising:
a first housing member comprising a first opening and a first magnet, wherein at least a portion of the first housing member forms a front face of the apparatus;
a second housing member comprising a second opening and a second magnet, and wherein at least a portion of the second housing member forms a rear face of the apparatus; and
a hinge between the first opening and the second opening, wherein the first housing member is adapted to be pivotable about the hinge, wherein the first magnet and the second magnet are opposite each other and spaced from the hinge, and wherein the first opening and the second opening form a hole extending from the front face to the rear face of the apparatus.

9. An apparatus as in claim 8 wherein the hinge is a swivel hinge comprising an aperture extending therethrough.

10. An apparatus as in claim 8 wherein a portion of the second magnet is at an exterior side face of the second housing member.

11. An apparatus as in claim 8 wherein the second housing member comprises a third magnet spaced from the second magnet, and wherein the first magnet and the third magnet are adapted to lock the apparatus in at least one position.

12. An apparatus as in claim 11 wherein the first magnet and the second magnet are opposite each other when the apparatus is in an open position, and wherein the first magnet and the third magnet are opposite each other when the apparatus is in a closed position.

13. An apparatus as in claim 8 wherein the first magnet and the second magnet are adapted to lock the apparatus in at least one position.

14. An apparatus as in claim 8 wherein the apparatus further comprises a light ring at the hinge, wherein the light ring is configured to illuminate a specified color based on a predetermined event.

15. An apparatus as in claim 8 wherein the apparatus is a swivel style mobile phone.

16. A method comprising:
providing a first housing member comprising a first opening and a first magnet;
providing a second housing member comprising a second opening and a second magnet, wherein the first opening is aligned with the second opening, and wherein the second magnet is opposite the first magnet; and
connecting a rotatable hinge between the first opening and the second opening, wherein the rotatable hinge comprises an aperture having a central axis, wherein the first housing member and the second housing member are rotatable about the central axis, and wherein the aperture extends from an exterior side face of the first housing member to an exterior side face of the second housing member.

17. A method as in claim 16 wherein the first magnet and the second magnet are spaced from the rotatable hinge.

18. A method as in claim 16 wherein the providing of the first housing member and the second housing member further comprises movably connecting the first housing member to the second housing member, and wherein the aperture extends through another exterior side face of the first housing member and another exterior side face of the second housing member.

19. A method as in claim 16 wherein the first housing member comprises a barrier portion between the first magnet and the second magnet.

20. A method as in claim 16 further comprising providing a third magnet on the second housing member, and wherein the first housing member and the second housing member form a mobile phone.

21. A method as in claim 20 wherein the first magnet and the second magnet are opposite each other when the mobile phone is in an open position, and wherein the first magnet and the third magnet are opposite each other when the mobile phone is in a closed position.
